(19) United States
(12) Patent Application Publication
(10) Pub. No.: US 2012/0300970 A1
(43) Pub. Date: Nov. 29, 2012

(54) Head Set

(76) Inventor: Florian PRÖLL, Vienna (AT)

(21) Appl. No.: 13/567,021

(22) Filed: Aug. 4, 2012

Related U.S. Application Data
(63) Continuation of application No. PCT/AT2011/000076, filed on Feb. 11, 2011.

(30) Foreign Application Priority Data
Feb. 11, 2010 (AT) A 203/2010

(51) Int. Cl. H04R 1/10

(52) U.S. Cl. 381/375

(57) ABSTRACT

A head set includes a cable winding device arranged in the housing for winding cables on both sides in a spring-supported manner, the cable winding device having at least one locking device, and including a microphone and at least one earphone or headphone, with the cable winding device including two take-up reels connected to each other in a rotationally fixed manner, and the take-up reels having different diameters. The microphone is arranged on the housing and it is connected to one of the take-up reels in a rotationally fixed manner and is rotatably supported relative to the housing.

### CROSS-REFERENCE TO RELATED APPLICATIONS

This utility patent application is a continuation of international patent application PCT/AT2011/000076 filed on Feb. 11, 2011, and claims priority to Austrian patent application A 203/2010 filed on Feb. 11, 2010, which are incorporated by reference herein.

### TECHNICAL FIELD

The invention relates to audio head sets and, more particularly, head sets for consumer electronic devices.

### BACKGROUND

Head sets for consumer electronics devices often have a microphone is connected electrically and mechanically at a fixed location in the cable. Specially manufactured devices are required for comfortable speaking with these corded head sets in order to attach the microphone to clothing or other items to achieve an optimal mouth-microphone distance, or the device containing the microphone or the microphone itself must be placed correspondingly close to the mouth.

Head sets of the type mentioned above have the disadvantage that the cord becomes entangled between the earphones and the terminal device, particularly a mobile telephone. In addition to the inconvenient handling when talking or when stowing the head set, it proves to be a further disadvantage that securing the microphone may cause damage, either to the fastening device and/or to the medium where the microphone is attached, or that it requires additional effort to position the microphone for trouble-free use when speaking.

Similar housings with a spring-supported cable winding device are also known from consumer electronics or computer accessories, where said devices can retract either one end of a cable or both cable ends of equal length simultaneously or independent of each other. Commercially available models that retract both ends of the cable have no microphone and the winding device is located roughly in the middle of the total cable length. Other commercially available models that have two independently retractable cable ends must feature a sliding contact or a similar rotary contact. Furthermore, these commercially available models provide for positioning of the microphone in the earphones.

DE 100 53 949 A1 describes a winding device for a connecting cable, where a take-up reel comprises two winding chambers positioned one above the other and potentially of different sizes, in each of which a portion of the cable is wound up and where a leaf spring provides pre-tensioning.

US 2002/0040945 A1 also discloses a winding device for a connecting cable with a take-up reel for synchronous winding of the cable to the earphone and of the cable going to the connector. The microphone is located outside the housing, along the cable to the earphone, such that the microphone-earphone-distance is constant.

By contrast, US 2008/0283651 A1 describes a winding device with the capability of adjusting the distance of the mobile phone and therefore also of the microphone to the respective conditions. Due to the mechanical design of the strap around the neck, the winding device has always a constant distance to the mouth, depending on the particular carrier.

WO 2003/031307 A1 also describes a winding device, which, however, is directly integrated into another device or connected via a socket, and the distance of the earphone to the device can be adjusted as desired.

### SUMMARY

The invention relates to a head set, comprising a cable winding device arranged in the housing for winding cables on both sides in a spring-supported manner, the cable winding device having at least one locking device, and comprising a microphone and at least one earphone or headphone, with the cable winding device comprising two take-up reels connected to each other in a rotationally fixed manner, and the take-up reels having different diameters, preferably for cables for transmitting audio or video signals.

According to the invention, the aforementioned problems are solved in that the microphone is arranged on the housing and in that the microphone is connected to one of the take-up reels in a rotationally fixed manner and is rotatably supported relative to the housing.

In this manner, the microphone can turn together with the take-up reels during winding and unwinding, and due to the different diameters of the two take-up reels, different cable lengths are wound up during the winding process.

Further embodiments of the object of the invention are characterized in the dependent claims and become apparent from the description and drawing.

### DESCRIPTION OF THE DRAWINGS

The object of the invention is illustrated in greater detail on the basis of the accompanying drawings:

FIG. 1 shows schematically a side view of the head set with a housing and cable winding device,

FIG. 2 shows schematically a front view of the head set with a housing and cable winding device,

FIG. 3 shows a side view of the schematic cross section through the center of the housing.

### DETAILED DESCRIPTION

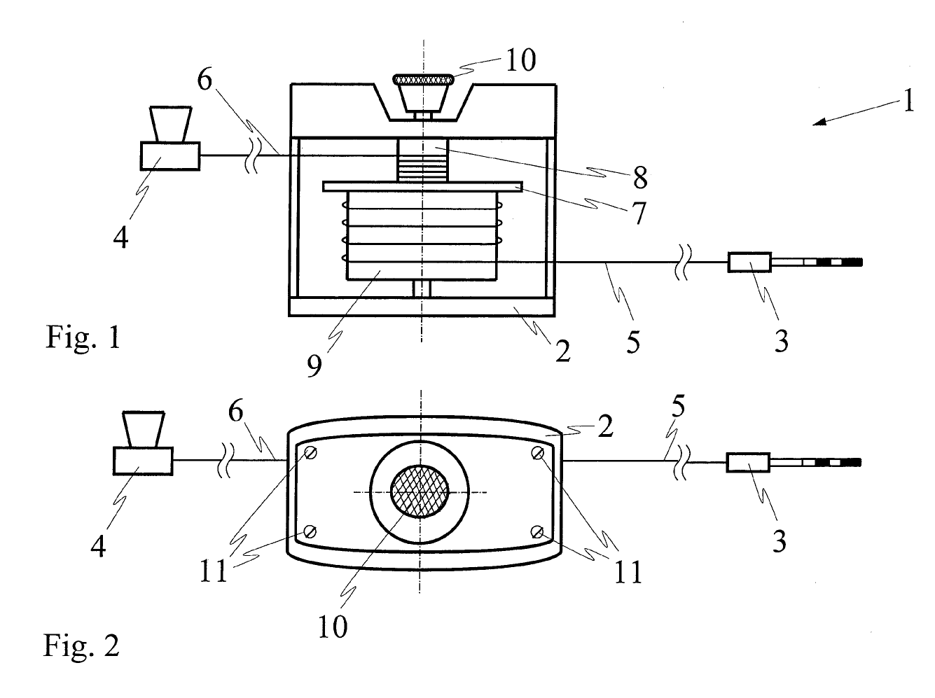

FIG. 1 shows a schematic presentation of the head set 1 in its entirety comprising an ear or head phone 4, a cable 6 with take-up reels 8, 9, where said cable together with a microphone 10 is arranged on or in a housing 2, and a cable 5 extending from the winding device 7, 8 to a connector by which a speech or audible signal can be transmitted to an audio and/or video device.

Starting from a not shown audio and/or video device with a socket, wire-bound audio and/or video signals are transmitted and can be reproduced by the head set 1. The electrical contact for the bidirectional signal transfer is established through the connector 3, which is designed in usual fashion in the form of an audio jack.

The manner of embodiment of plug 3 does not constitute a constraint on the present invention. The earphone or headphone 4 and the plug are connected via cables 5, 6, which are divided due to the take-up reels 8, 9 with different diameters such that the end of the cable 6 to the earphone or headphone 4 is shorter than the cable end 5 to the connector 3. The two cable ends 5, 6 exhibit a branch for the microphone 10.

Thus, the feed cable 5 consists of at least 2 electrical lines for transmitting the signal to be heard and at least one additional line for the microphone 10, while the cable 6 to the earphone or headphone 4 is equipped with at least 2 lines because only the signals to be heard need to be transmitted.

To increase the quality of the transmitted signals and to facilitate winding the cable, it is recommended to use shielded and preferably rectangular cables 5, 6. If the earphone or headphone 4 is designed in stereo, a corresponding plurality of lines is required.

To position the microphone 4 in an optimum manner in speech height, in order to thereby obtain the speech comfort, the microphone position should be in the vicinity of the mouth.

According to the invention, this is accomplished in that the length of the cable 6 on the side of the earphone or headphone can be unwound in small distances. At the same time, the object of the invention ensures that the other device-side end of the cable 5 remains longer and thus does not affect the wearing comfort. The different unwinding is accomplished by the different dimensions of the cable take-up reels 8, 9 and can be calculated on the basis of the take-up reel 8, 9 diameters.

To avoid the cables 5, 6 from getting wedged or from sliding into each other on the cable take-up reels 8, 9, an additional spatial separation is established between the two take-up reels 8, 9, preferably through a disk-shaped element 7. A not shown but also possible alternative is to attach a disk with a central opening to the inside of the housing 2. This provides greater mechanical stability for the housing 2 and the assembly is easy.

An axis in the form of a mandrel 15 is firmly connected to the housing 2 to ensure optimal turning of the cable take-up reels.

A locking device, which is typically represented by a sphere 14 running in a guide is provided between the lower end face of the take-up reel 9 and the housing 2. The exact design of the locking device is not an object of this invention.

FIG. 2 shows schematically a front view of the head set 1. Typically, the microphone is located above the rotational axis of the cable take-up reels 8, 9. The housing 2 can be designed differently, and this does not impair the function of the present invention. Typically, the housing 2 has plate-like elements that are connected rigidly to each other using screw, glue or plug-type connections 11.

Preferably, the shape of the cable take-up reels 8, 9 is adapted such that the housing 2 projects beyond them in size and in addition to the different cable lengths also includes space for fasteners including screw connections 11 and not shown struts.

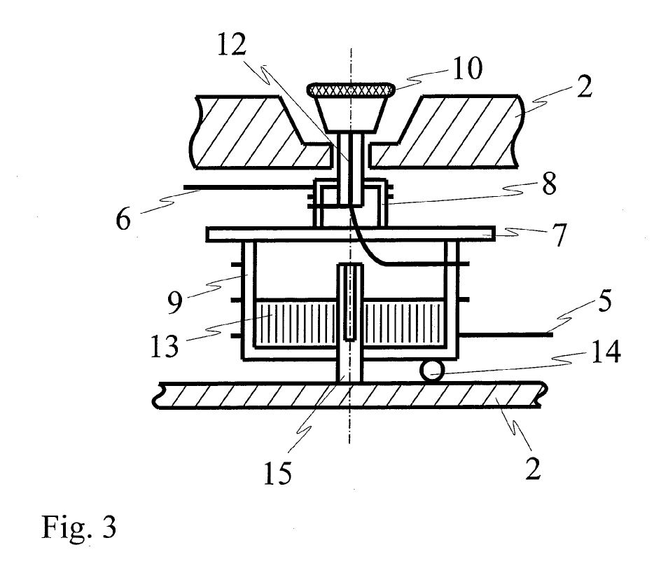

FIG. 3 shows a side view of the schematic cross section through the center of the housing, which illustrates the inner parts. Preferably, the microphone 10 attached to the housing 2 can also be sunk into the housing to prevent possible damage. The microphone 10 is connected to the top cable take-up reel 8 via a preferably hollow pin 12. Mounted in the pin 12 is an additional cable, which exhibits an electrical connection to the microphone 10 and the incoming and outgoing cables 5, 6.

The two cable ends 5, 6 are wound onto the cable take-up reels 8, 9, introduced into the respective cable take-up reel 8 or 9 and at the rotational axis of the reels connected electrically to the cable in the pin 12 and the respective other cable ends 5 or 6. To reduce noise and increase the reliability of the electrical connection, this connection according to the invention is designed without sliding contacts, i.e., by means of plug or piercing connections or solder joints.

A common mechanism that employs a spring 13 is used for the automatic winding of the cable ends 8, 9; this spring is connected in a fixed manner in the rotational axis, preferably by plugging into a slot at the mandrel 15 and is under mechanical tension. The other end of the spring 13 is attached to the, preferably lower, take-up reel 9.

1. A head set, comprising:
a housing;
a microphone on the housing;
at least one earphone or headphone;
cables;
a cable winding device arranged in the housing to wind the cables on both sides in a spring-supported manner, the cable winding device having at least one locking device, with the cable winding device comprising two take-up reels connected to each other in a rotationally fixed manner, and the take-up reels having different diameters, wherein the microphone is connected in a rotationally fixed manner to one of the take-up reels and is supported rotatably relative to the housing.

2. The head set as set forth in claim 1, further comprising a separating element provided for the spatial separation of the two take-up reels.

3. The head set as set forth in claim 2, wherein the separating element comprises a disk.

4. The head set as set forth in claim 2, wherein the microphone is arranged in a height-adjustable manger relative to the housing for operating an on/off switch.

5. The head set as set forth in claim 1, wherein the microphone is arranged in a height-adjustable manner relative to the housing for operating an on/off switch.

6. The head set as set forth in claim 1, further comprising a disk rigidly coupled between the take-up reels.
